(19) United States
(12) Patent Application Publication
(10) Pub. No.: US 2025/0005951 A1
(43) Pub. Date: Jan. 2, 2025

(54) LOCATING MACHINE-READABLE ZONES IN IMAGES BASED ON FEATURE POINTS

(71) Applicant: Smart Engines Service, LLC, Moscow (RU)

(72) Inventors: Boris Igorevich SAVELEV, Moscow (RU); Natalya Sergeevna SKORYUKINA, Moscow (RU); Vladimir Viktorovich ARLAZAROV, Moscow (RU)

(21) Appl. No.: 18/416,699

(22) Filed: Jan. 18, 2024

(30) Foreign Application Priority Data
Jun. 29, 2023 (RU) 2023117243

(51) Int. Cl. G06V 30/414; G06K 7/14; G06T 7/73; G06V 30/16; G06V 30/186; G06V 30/19

(52) U.S. Cl. CPC G06V 30/414; G06K 7/1443; G06T 7/73; G06V 30/16; G06V 30/186; G06V 30/19107; G06T 2207/20061; G06T 2207/30176

(57) ABSTRACT

A method for locating machine-readable zones in document images based on feature points is disclosed. In an embodiment, feature points are found in the image, and linear objects are located in the image (e.g., by applying a Fast Hough Transform to the image). The feature points are filtered based on their correspondence to the linear objects. The filtered feature points are grouped into clusters, and rectangular zones are defined around each cluster. A final rectangular zone is selected from the defined rectangular zones. This method of locating machine-readable zones is designed to meet the requirements for real-time operation on mobile devices.

### CROSS-REFERENCE TO RELATED APPLICATIONS

The present application claims priority to Russian Application No. 2023117243, filed on Jun. 29, 2023, which is hereby incorporated herein by reference as if set forth in full.

### TECHNICAL FIELD

The invention relates to the field of image analysis, and more specifically, to a fast and accurate location of a machine-readable zone (MRZ) in an image based on a combination of a search for linear objects and a search of feature points.

### BACKGROUND

Modern technologies in document processing systems speed up the work of access control points and reduce the number of errors in comparison with manual input. In order to implement recognition systems, the International Civil Aviation Organization (ICAO) has developed a standard for passports and other travel documents. On documents developed according to the standard, in addition to the usual data fields, there is a special machine-readable zone (MRZ), which contains complete information about the type of document, the owner, and checksums.

At the moment, in addition to the ICAO, there are several standards for machine-readable documents, and within each, several types of MRZ. Each of the types has fixed characteristics, including geometric ones (e.g., aspect ratio of the zone). Some countries have adopted their own MRZ standards, which are identical in geometric characteristics to the MRZ. Some examples of MRZ types are shown in FIGS. 1A-1D: a Switzerland Driver's license (FIG. 1A), a France ID card (FIG. 1B), ICAO MRV-1 (FIG. 1C), and ICAO TD1 (FIG. 1D).

A basic solution for standardized document recognition is special passport scanners, which allow one to get an image in significantly less time compared to conventional scanners. However, the image quality from passport scanners can be significantly lower. Depending on the type of scanner, the resulting images contain either a machine-readable zone directly or, like a conventional scanner, a document in its entirety without scene elements.

Another solution uses smartphones with mobile software for scanning documents, including documents with the MRZ recognition function. This significantly reduces the cost and speeds up the equipment of control points, but imposes additional requirements on the software part of the system. Low-budget mobile devices produce low-quality images and are limited by their own computing power. Since the data of the machine-readable zone include personal information, the transmission of the data over network(s) is undesirable and might be subject to data privacy and security regulations. Thus, the developed software must work in real-time, even on low-power devices, and maintain high-quality recognition on images obtained from low-resolution cameras.

A number of problems arise when capturing images of machine-readable documents using small-format digital cameras, including, for example: (i) manifestations of “digital noise” and artifacts of compression algorithms; (ii) brightness differences, glare, and color distortions; (iii) document rotation and projective distortion; and (iv) bending of document lines.

MRZ detection/location may be applied under the following restrictions: (1) the MRZ is clearly visible in the image and occupies a significant part of it (e.g., at least one-third of the frame width) and all letters are fully distinguishable; (2) the frame may or may not contain the entire document, and the MRZ may be located in an arbitrary area of the frame; and (3) the area outside the document may contain background padding. In this setting, the approach based on the search and recognition of the entire text in the image with the subsequent search in the recognized text for information related to the machine-readable zone becomes too expensive. Instead, it is preferable to be able to quickly locate the MRZ in the image before recognition, for subsequent segmentation, and recognition of only this fragment of the image.

Since the introduction of standards for documents, several approaches to MRZ search have been developed. One of the first such methods proposed an analysis of the vertical and horizontal projections of the image. This is a good approach for images obtained from a scanner, but it is not applicable for the task at hand (i.e., using a mobile device camera), since the document may be rotated at a random angle or projectively distorted, and the background filling may be non-uniform. For the same reason, another popular method-horizontal morphological blurring on a binarized image in combination with contour analysis-cannot be used.

Although some studies have considered the case of a slight tilt of the document in the image and its evaluation using the Hough and Fourier transforms for subsequent correction, their applicability was evaluated based on the following assumptions: (1) the MRZ is the key source of straight lines in the image; and (2) binarization successfully turns the text to black and the background to white. The camera frame can capture various elements of the environment and significant lighting differences, so both of these assumptions are incorrect for the task in question.

### SUMMARY

Accordingly, systems, methods, and non-transitory computer-readable media are disclosed for fast and accurate location of a machine-readable zone (MRZ) in an image based on a combination of a search for linear objects and a search of feature points.

In an embodiment, a method of locating a machine-readable zone (MRZ) in an image comprises using at least one hardware processor to: find a plurality of feature points in the image; locate one or more linear objects in the image; filter the plurality of feature points based on a correspondence of the plurality of feature points to the one or more linear objects; group the plurality of filtered feature points into one or more clusters; define one or more rectangular zones around each of the one or more clusters; and select a final rectangular zone from the one or more rectangular zones.

The method may further comprise, prior to finding the plurality of feature points, preprocessing the image. Preprocessing the image may comprise performing one or more of scaling, grayscale conversion, or Gaussian smoothing. The method may further comprise obtaining one or more image processing parameters, wherein preprocessing the image is performed based on the one or more image processing parameters.

Locating one or more linear objects in the image may comprise applying a Fast Hough Transform (FHT) to the image. Applying the FHT to the image may comprise calculating a number of candidate lines in the image using the FHT, and filtering the plurality of feature points may comprise, for each feature point: determining a nearest straight line to the feature point among the candidate lines; calculating a minimum distance from the feature point to the nearest straight line; when the minimum distance is smaller than a threshold distance, including the feature point in the plurality of filtered feature points; and when the minimum distance is not smaller than the threshold distance, excluding the feature point from the plurality of filtered feature points. The method may further comprise obtaining a maximum possible height of an MRZ symbol and determining the threshold distance based on the maximum possible height.

Locating one or more linear objects in the image may comprise applying a Fast Hough Transform (FHT) to the plurality of feature points.

Grouping the plurality of filtered feature points into one or more clusters may comprise: generating a graph of the plurality of filtered feature points based on a weight of an edge between two points; defining a minimal spanning tree of the graph; and dividing the minimal spanning tree into the one or more clusters.

The method may further comprise obtaining one or more MRZ parameters. The one or more MRZ parameters may comprise one or more geometric features of MRZ types. The one or more geometric features may comprise aspect ratios of the MRZ types. Selecting the final rectangular zone may be performed based on the one or more MRZ parameters.

Selecting the final rectangular zone may comprise: determining that two or more clusters are structurally identical; searching for an MRZ-specific character within the two or more clusters; and selecting the final rectangular zone based on the search.

In an embodiment, a mobile user device comprises: a camera; at least one hardware processor; and software configured to, when executed by the at least one hardware processor, capture an image of a document using the camera, find a plurality of feature points in the image, locate one or more linear objects in the image, filter the plurality of feature points based on a correspondence of the plurality of feature points to the one or more linear objects, group the plurality of filtered feature points into one or more clusters, define one or more rectangular zones around each of the one or more clusters, and select a final rectangular zone from the one or more rectangular zones.

In an embodiment, a non-transitory computer-readable medium has instructions stored thereon, wherein the instructions, when executed by a processor, cause the processor to: find a plurality of feature points in the image; locate one or more linear objects in the image; filter the plurality of feature points based on a correspondence of the plurality of feature points to the one or more linear objects; group the plurality of filtered feature points into one or more clusters; define one or more rectangular zones around each of the one or more clusters; and select a final rectangular zone from the one or more rectangular zones.

It should be understood that any of the features above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIGS. 1A-1D show examples of MRZ types;

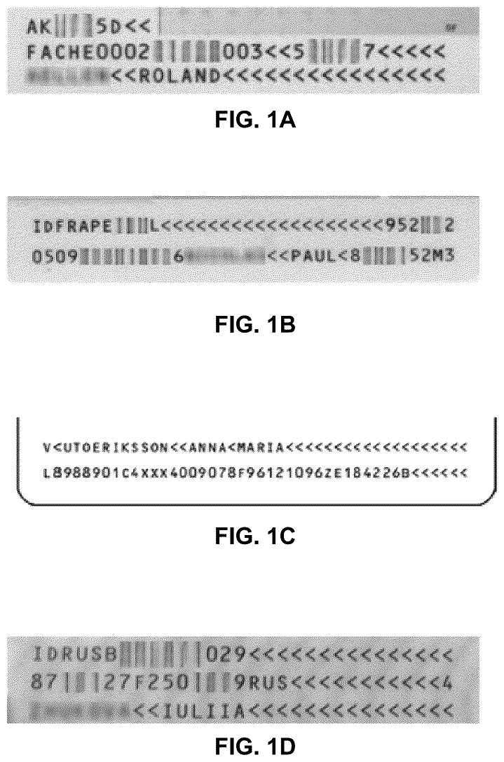

FIG. 2 illustrates an example processing system, by which one or more of the processes described herein, may be executed, according to an embodiment;

FIG. 3 is a flow diagram of an algorithm for localizing a machine-readable zone in an image, according to an exemplary embodiment;

FIG. 4 shows an example of an image snapshot to which the algorithm of FIG. 3 may be applied;

FIGS. 5-7 show the image snapshot of FIG. 4 during various processing steps of the algorithm of FIG. 3;

FIG. 8 shows a comparison of MRZ detection using the algorithm of FIG. 3 and a different detection algorithm; and

FIG. 9 shows an evaluation of the quality of the MRZ detection method using the algorithm of FIG. 3.

### DETAILED DESCRIPTION

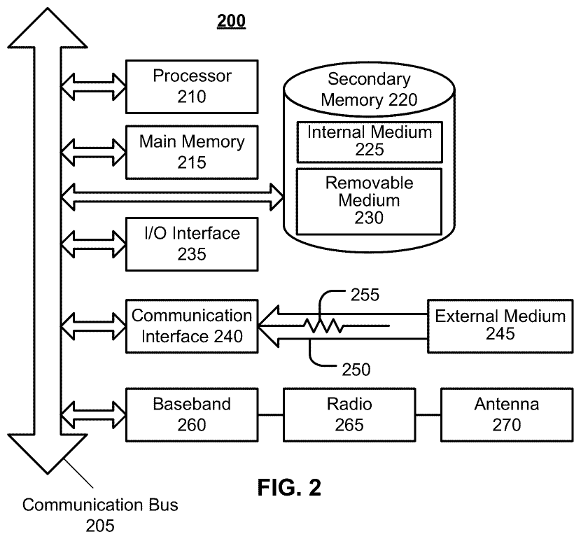

FIG. 2 is a block diagram illustrating an example wired or wireless system 200 that may be used in connection with various embodiments described herein. For example, system 200 may be used as or in conjunction with one or more of the functions, processes, or methods described herein (e.g., to store and/or execute the implementing software). System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE), and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), flash memory (block-oriented memory similar to EEPROM), and the like.

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and the like.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., display console 158, or in a smartphone, tablet computer, or other mobile device).

System 200 may include a communication interface 240. Communication interface 240 allows software and data to be transferred between system 200 and external devices (e.g. printers), networks, or other information sources. For example, computer software or executable code may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

System 200 may also include optional wireless communication components that facilitate wireless communication over a voice network and/or a data network. The wireless communication components may comprise an antenna system 270, a radio system 265, and a baseband system 260. Baseband system 260 is communicatively coupled with processor(s) 210. In system 200, radio frequency (RF) signals are transmitted and received over the air by antenna system 270 under the management of radio system 265.

In an embodiment, a method for locating machine-readable zones in document images based on a combination of the Hough transform and the search for feature points is disclosed. The search for feature points, filtering, and clustering using the Hough transform are described step-by-step. In addition to the machine-readable zone location, a solution for determining the orientation of the zone has been developed. This method is designed to meet the requirements for real-time operation on mobile devices. The method uses the fact that the characteristics (e.g., the absolute size of the zone and characters, the number of lines and characters per line, etc.) of each type of MRZ are stable and known.

The closest approach to the problem under consideration is searching for the MRZ through the selection of text blocks using the morphological filter Toggle Mapping. But such an approach shows low frame-by-frame search efficiency, even on data synthesized without taking into account the natural bends of the document and lighting.

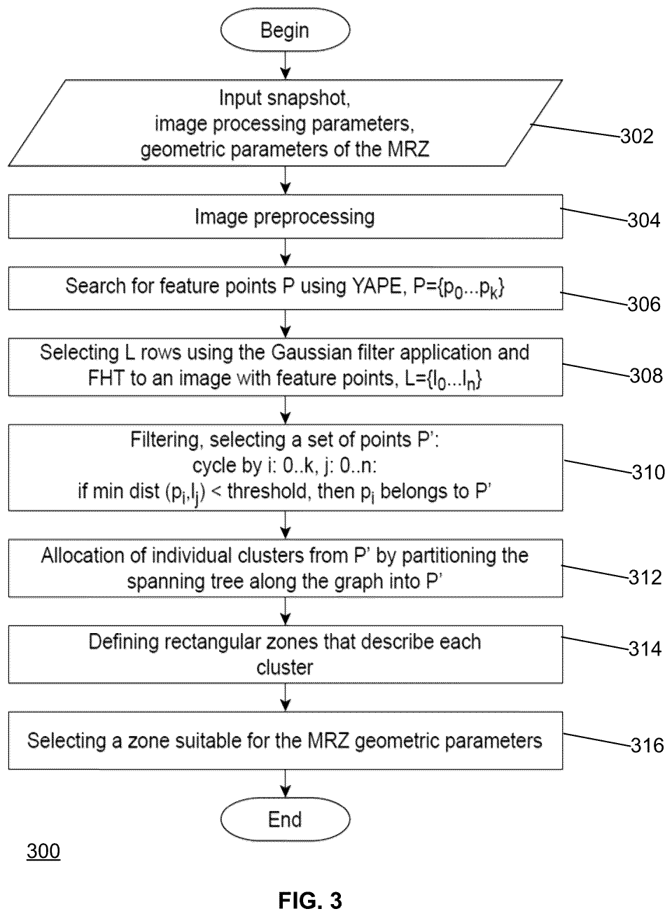

FIG. 3 shows a flow diagram of the main steps of a process/algorithm 300 for locating an MRZ in an image, according to an exemplary embodiment. The algorithm 300 is based on the selection and clustering of feature points, followed by analysis, transformation, and clipping of clusters based on geometric features. Some or all of the steps of the algorithm 300 may be implemented using the system 200 of FIG. 2.

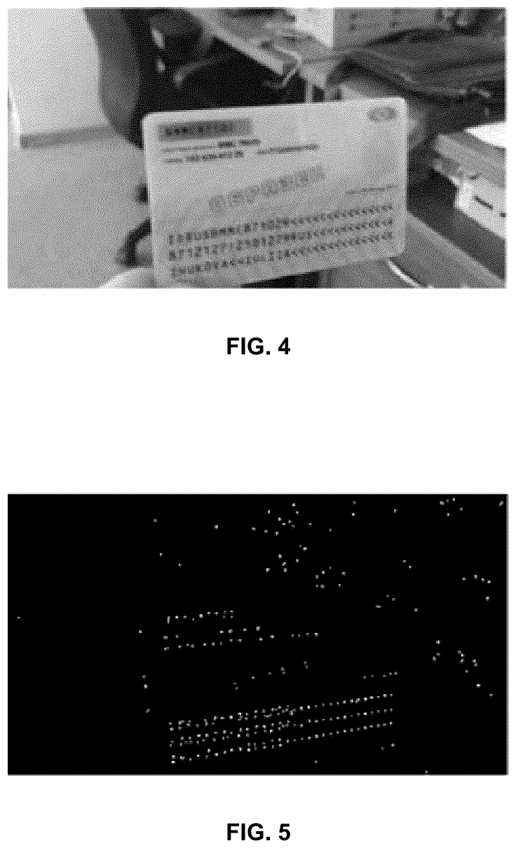

In step 302, the algorithm 300 receives the image (input snapshot shown in FIG. 4), image processing parameters, and geometric parameters of the MRZ.

### Preprocessing and Searching for Feature Points (Steps 304-306)

The algorithm 300, in step 304, preprocesses the image and in step 306, finds/searches for feature points P={p₀, . . . pₖ} in the preprocessed image.

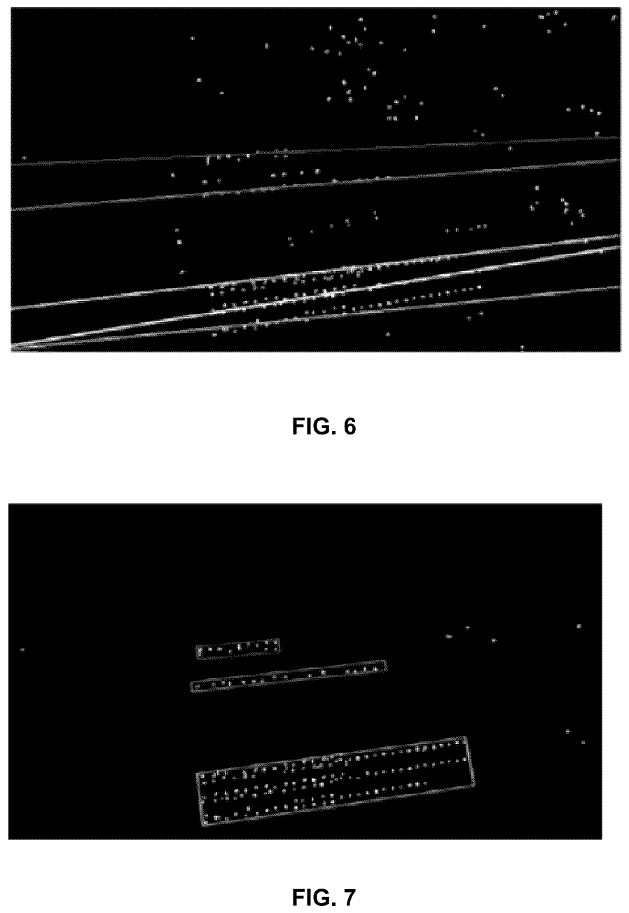

In an exemplary embodiment, the detection of feature/key points 306 is performed by the Yet Another Parser/Extractor (YAPE) key point detection method. As an example, FIG. 4 shows an input snapshot (i.e., the image), and FIG. 5 shows a result of a search for feature points in the image using YAPE. The following requirements were formulated for the method of selecting feature points: (i) speed; (ii) high density of text coverage, especially machine-readable (at least one point per symbol); and (iii) ignoring areas with straight borders.

In one embodiment, in step 304, the input image is pre-scaled to a fixed size (800 pixels in width), converted to gray, and smoothed using a Gaussian filter with σ=1. Scaling, in addition to additional noise reduction, is associated with one of the YAPE parameters—the maximum radius of the area that is analyzed for each point. For a comparable result of the algorithm on images of different resolutions, the radius must correlate with the resolution (the higher the resolution the larger the radius), which, unlike pre-scaling, means a significant slowdown (quadratic dependence) on large images with minimal impact on the further algorithm.

### Filtering Points (Steps 308-310)

In order to discard the points that most probably do not belong to the desired zone, we use the assumption that a) the lines of the machine-readable zone are the longest text object on the document, and b) the selected feature point detector does not select points belonging to continuous boundaries (straight lines in an image), and apply the following scheme:

In step 308, the algorithm 300 selects L rows using the Gaussian filter application and applying the Fast Hough Transform (FHT) to the image. In the exemplary embodiment, n candidate lines are calculated in an image containing feature points using the fast Hough transform. The Hough transform may be implemented using the method described in “Hough transform: underestimated tool in the computer vision field. European Conference on Modeling and Simulation, 2008” by Nikolaev D. P., Nikolaev I. P, Nikolaev P. P., and Karpenko S. M., which is incorporated herein by reference. While embodiments will primarily be described as using a Hough transform, such as FHT, candidate lines may be located using other means, such as least-squares estimation, an artificial neural network, or the like.

In step 310, the algorithm 300 selects a set P′ of feature points P by filtering the feature points using the following steps. For each point pᵢ, determine the nearest straight line among the candidates lᵢ. Discard the point if the distance dₘᵢₙ to the nearest straight line is greater than or equal to a threshold T. Keep the point if min distance (pᵢ, lᵢ)<T.

In one exemplary embodiment, the threshold is set to T=0.5·h_{sym}, where h_{sym} is the maximum possible height of the MRZ symbol in the fixed-size image.

### Point Clustering (Step 312)

In step 312, the algorithm 300 combines/allocates the selected points P′ into clusters as follows:

First, the algorithm 300 builds a complete graph in which the points are vertices, and the weight of the edge between the points pᵢ and pⱼ is calculated using the following formula:

$${w}_{ij} = f ( angle ) \cdot {dist}_{ij} , \qquad ( 1 )$$

where distᵢⱼ is the distance between every two points, f is some monotone function, angle is the minimal angle between the lines lᵢ and lⱼ. This weight wᵢⱼ is used to penalize cases that are not similar to parallel MRZ strings.

Next, the algorithm 300 defines a minimal spanning tree of the graph.

Finally, the algorithm 300 divides the tree into several parts (clusters), throwing out the edges whose weight is greater than the threshold (for example, T=2·w_{sym}, where w_{sym} is the maximum possible width of the MRZ symbol in the image of the fixed size). If the cluster size (i.e., the number of points in the cluster) is less than the minimum allowed number of MRZ characters in the string, then the cluster is discarded.

### Cluster Analysis, Selection of the Resulting Rectangle (Steps 314-316)

In step 314, the algorithm defines rectangular zones that describe each cluster. In an exemplary embodiment, for each of the obtained clusters, the angle of inclination to the sides of the image is determined as the average of the angles of the lines corresponding to the points included in the cluster. Then, a rectangle is circumscribed around the cluster points, located at this angle. FIG. 6 shows straight lines corresponding to text strings, and FIG. 7 shows three clusters within rectangular zones, which may be defined in step 314.

In step 316, a final rectangle/zone is selected from the rectangles defined in step 314. The final rectangle is selected such that the rectangle has the greatest correspondence (out of all the rectangles of the previous step 314) to the known geometric constraints of any of the MRZ zones.

In a case where several clusters are structurally identical, the raster within each cluster is analyzed. The “<” character is an MRZ-specific separator, i.e. it occurs at least 2 times in the vast majority of cases and is usually not present in other text fields. This separator is stably detected as a feature point, so it is sufficient to analyze the local neighborhoods of the points at the beginning and end of the cluster.

For this, the reference image of the “<” symbol is represented as a local descriptor. In an exemplary embodiment, the binary descriptor, called the receptive fields descriptor (RFD), is used. The RFD is described in the paper “Receptive fields selection for binary feature description. IEEE Transactions on Image Processions, 2014, vol. 24, no. 6, pp. 2583-2595,” by Fan B., Kong Q., Trzcinski T., Wang Z., Pan C., and Fua P., which is incorporated herein by reference.

Note that not all of the 37 characters used in the MRZ alphabet may be used as local descriptors, because the OCR-B font can occur in the document's fill-in text, and not just in the MRZ.

The algorithm 300 cuts out the neighborhoods around the feature points from the cluster from the original image, taking into account the size and rotation angle of the cluster, and then calculates the RFD descriptors for the neighborhoods. It should be understood that each neighborhood represents a local area around the center of a feature point. For each such descriptor, the algorithm calculates the Hamming distance with the reference descriptor. The character detection is considered to be successful if the distance is less than the threshold. The weight for the cluster is calculated as:

$$( 1 - \frac{number of mappings}{number of points} ) \cdot mean Hamming distance$$

The smaller the weight, the more similar the cluster is to the MRZ.

In an embodiment, because the stability of the RFD to rotation is limited (about 15 degrees), and the rotation of the text is unknown at this stage, the “<” descriptors are calculated in two rotations: 0 and 180 degrees. The check is performed for each turn independently, the one with the greater weight is selected.

While process 300 is illustrated with a certain arrangement and ordering of subprocesses, process 300 may be implemented with fewer, more, or different subprocesses and a different arrangement and/or ordering of subprocesses. It should be understood that any subprocess, which does not depend on the completion of another subprocess, may be executed before, after, or in parallel with that other independent subprocess, even if the subprocesses are described or illustrated in a particular order.

### Experimental Results

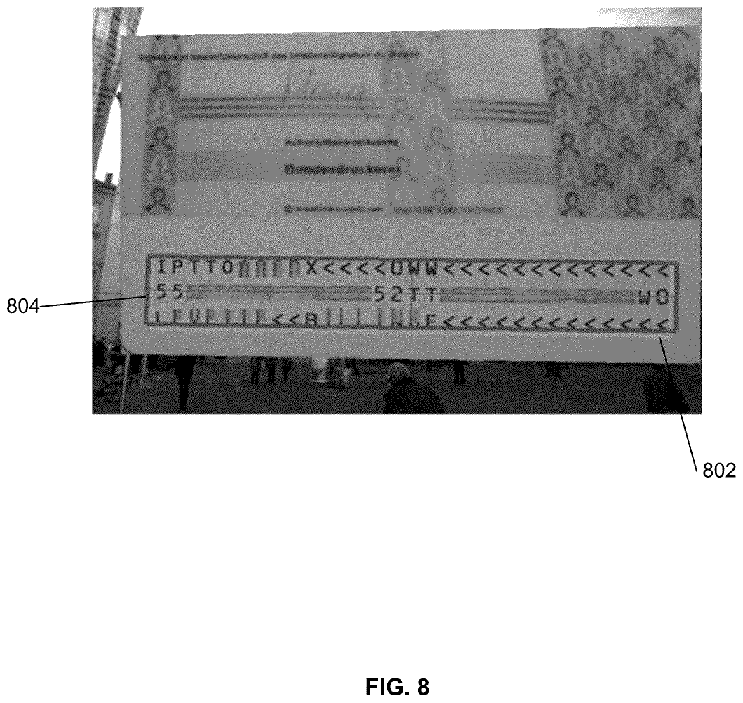

The developed algorithm 300 was tested using the MRZ recognition module on an image containing a machine-readable zone (FIG. 8). To evaluate the quality of the algorithm, a synthetic dataset was used. The synthetic dataset consisted of 456,000 artificial images, with a document containing the MRZ. To annotate all images, a different detection algorithm from SmartIDReader was used and results were converted to ground truth. MRZ was not found on all images, so only 422,338 images were annotated. Although the algorithm evaluation with such ground truth cannot be considered accurate, it can be used to estimate an approximate value.

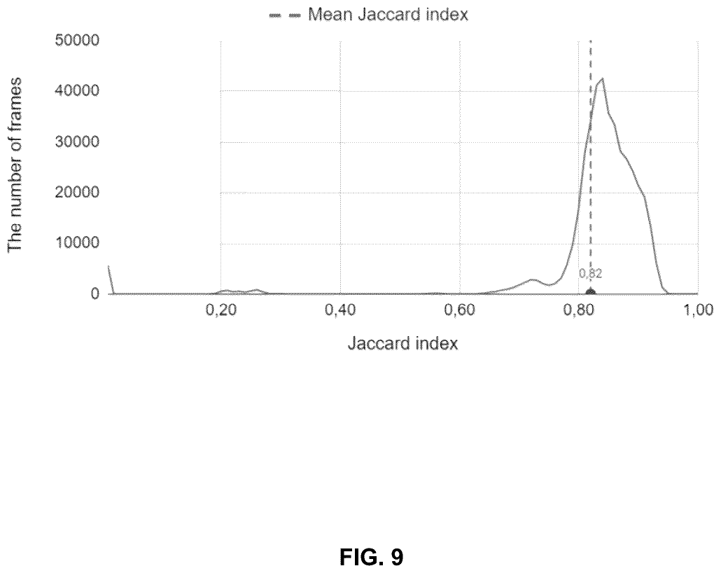

FIG. 8 shows an example of MRZ detection using the developed algorithm 300 (darker rectangle 804) and ground truth (lighter rectangle 802). The quality of the detection was evaluated using the Jaccard metric. The final quality is shown in FIG. 9 as a mean of Jaccard indices, equal to 0.82.

The average MRZ detection time on the iphone 5s was 40 ms, and on the iPhone SE 2 was 6 ms.

The proposed algorithm 300 achieved a quality of 0.82 in terms of the mean value of the Jaccard indices, and the speed of execution of the algorithm on mobile devices allows for real time implementation using mobile devices.

What is claimed is:

1. A method of locating a machine-readable zone (MRZ) in an image, the method comprising using at least one hardware processor to:
find a plurality of feature points in the image;
locate one or more linear objects in the image;
filter the plurality of feature points based on a correspondence of the plurality of feature points to the one or more linear objects;
group the plurality of filtered feature points into one or more clusters;
define one or more rectangular zones around each of the one or more clusters; and
select a final rectangular zone from the one or more rectangular zones.

2. The method of claim 1, further comprising, prior to finding the plurality of feature points, preprocessing the image.

3. The method of claim 2, wherein preprocessing the image comprises performing one or more of scaling, grayscale conversion, or Gaussian smoothing.

4. The method of claim 2, further comprising obtaining one or more image processing parameters, wherein preprocessing the image is performed based on the one or more image processing parameters.

5. The method of claim 1, wherein locating one or more linear objects in the image comprises applying a Fast Hough Transform (FHT) to the image.

6. The method of claim 5, wherein applying the FHT to the image comprises calculating a number of candidate lines in the image using the FHT, and wherein filtering the plurality of feature points comprises, for each feature point:
determining a nearest straight line to the feature point among the candidate lines;
calculating a minimum distance from the feature point to the nearest straight line;
when the minimum distance is smaller than a threshold distance, including the feature point in the plurality of filtered feature points; and
when the minimum distance is not smaller than the threshold distance, excluding the feature point from the plurality of filtered feature points.

7. The method of claim 6, further comprising obtaining a maximum possible height of an MRZ symbol and determining the threshold distance based on the maximum possible height.

8. The method of claim 1, wherein locating one or more linear objects in the image comprises applying a Fast Hough Transform (FHT) to the plurality of feature points.

9. The method of claim 1, wherein grouping the plurality of filtered feature points into one or more clusters comprises:
generating a graph of the plurality of filtered feature points based on a weight of an edge between two points;
defining a minimal spanning tree of the graph; and
dividing the minimal spanning tree into the one or more clusters.

10. The method of claim 1, further comprising obtaining one or more MRZ parameters.

11. The method of claim 10, wherein the one or more MRZ parameters comprise one or more geometric features of MRZ types.

12. The method of claim 11, wherein the one or more geometric features comprise aspect ratios of the MRZ types.

13. The method of claim 10, wherein selecting the final rectangular zone is performed based on the one or more MRZ parameters.

14. The method of claim 1, wherein selecting the final rectangular zone comprises:
determining that two or more clusters are structurally identical;
searching for an MRZ-specific character within the two or more clusters; and
selecting the final rectangular zone based on the search.

15. A mobile user device comprising:
a camera;
at least one hardware processor; and
software configured to, when executed by the at least one hardware processor,
capture an image of a document using the camera,
find a plurality of feature points in the image,
locate one or more linear objects in the image,
filter the plurality of feature points based on a correspondence of the plurality of feature points to the one or more linear objects,
group the plurality of filtered feature points into one or more clusters,
define one or more rectangular zones around each of the one or more clusters, and
select a final rectangular zone from the one or more rectangular zones.

16. A non-transitory computer-readable medium having instructions stored thereon, wherein the instructions, when executed by a processor, cause the processor to:
find a plurality of feature points in the image;
locate one or more linear objects in the image;
filter the plurality of feature points based on a correspondence of the plurality of feature points to the one or more linear objects;
group the plurality of filtered feature points into one or more clusters;
define one or more rectangular zones around each of the one or more clusters; and
select a final rectangular zone from the one or more rectangular zones.
